(19) United States
(12) Patent Application Publication
(10) Pub. No.: US 2012/0295236 A1
(43) Pub. Date: Nov. 22, 2012

(54) MODIFIED KEYBOARD WITH INSERTABLE KEYS AND AN INSTRUCTIONAL METHOD FOR TEACHING TOUCH-TYPING USING SAME

(76) Inventor: Susan Ellyn Miller, Somerville, MA (US)

(21) Appl. No.: 13/451,853

(22) Filed: Apr. 20, 2012

Related U.S. Application Data
(60) Provisional application No. 61/477,395, filed on Apr. 20, 2011.

(51) Int. Cl. G09B 13/04

(52) U.S. Cl. 434/227

(57) ABSTRACT

This invention provides a methodology for teaching touch-typing using a keyless keyboard whose keys are inserted one by one as instruction progresses. A beginner keyboard only contains the home keys (A S D F J K L;) or the letters (F and J) used by the pointer fingers, making it easier for the user's hands to find the keys correctly without having to look down at the letters. As each new letter is introduced, it is added to the keyboard. The letter key being taught is easier to find since there are no other keys in the vicinity for the user's fingers to go. This makes touch-typing easier because the only keys available are those that have been taught. The user's fingers will naturally go to those keys because there are no other keys on the keyboard.

### CROSS REFERENCE TO RELATED APPLICATIONS

This application claims the benefit of U.S. Provisional Patent Application No. 61/477395 filed Apr. 20, 2011, which is hereby incorporated by reference in its entirety.

### TECHNICAL FIELD

This invention relates to the teaching of touch-typing. More specifically, the invention relates to instruction in touch-typing using a keyless-keyboard with insertable keys.

### BACKGROUND

Typing and/or keyboarding skills are necessary for all aspects of computer usage, including composing documents or email, searching the web and updating personal/business calendars. These skills are no longer relegated to the high school student or those in the work world as children as young as 6 years old now use computers and their keyboards for both recreational and educational purposes, such as playing games and watching interactive videos teaching letter and number skills At the same time, schools are spending less time teaching handwriting to young children, leading to declining printing and cursive skills Also, given the inclusive model of special education mandated by law, classrooms now are made up of many children with learning disabilities that may cause difficulty in learning both handwriting and keyboarding. Furthermore, it is expected that schools will be moving more and more to using computer tablets where typing is done on the computer screen itself. It is extremely difficult to learn to type on such a touch screen because, without keys, there is no sensory feedback. For all these reasons, the early instruction of the touch-typing skills used in computer keyboarding are more important than ever.

Historically, typing was taught to students in high school. More recently, its formal introduction tends to begin anywhere from the third grade through middle school, when children's fine motor skills and attention span are considered to be at an appropriate level for standard instruction. There is, therefore, a gap of at least 3 years between the age at which many children use the computer keyboard and the age at which its use is formally taught.

When these skills are taught, the method of instruction is fundamentally that which was used during the days of the manual typewriter. Current instructional practices are not geared towards children younger than the 3rd grade, nor are they designed to facilitate the needs of children with special needs.

Young children who are lacking any formal instruction in touch keyboarding and novice keyboard users are left to use the ‘hunt and peck’ method, wherein they must look at the keyboard and search for the correct letter to type. This results in slow, often inaccurate typing which over time becomes habitual and difficult to unlearn. In addition, children with dysgraphia and dyspraxia (learning disabilities that make writing difficult), are often assigned typing as a method of classroom accommodation, yet these same individuals have similar difficulties coordinating their fingers when typing as they do when trying to control a pen or pencil; as a result, they too, often resort to the ‘hunt and peck’ method of typing.

Keyboards for typewriters and computers are well known. Touch-typing is the most efficient way of working on a keyboard. Skilled typists are able to copy text or create original text without looking at the keys; their fingers have learned the position of the home row of keys as well as each letter and symbol on the keyboard and they are automatically able to type words almost as fast as they can see them or conceive of them.

Touch-typing is not easy to learn, however. It can take up to several years of extensive practice to master the basics and longer than that to reach a high level of speed and accuracy. Many people never reach mastery, typing slowly and with a low level of accuracy, forcing them to either looking down at the keyboard and/or going through several rounds of editing in order to correct their errors.

Various methods of instruction have been proposed to make typing easier to learn. Although they present slight variations to traditional instruction, these solutions basically use the same method of teaching typing that has been used for over a century. The learner is presented with an intact keyboard, usually of the QWERTY style, and is taught to place their fingers on the home keys (A S D F J K L ;). Individual letters are then practiced in isolation and within the context of words until they are learned.

Several methods advocate a technique where colors on the fingers are matched to colors on the keys. The colors on the fingers can be displayed on finger bands, rings, or gloves. The finger bands or rings could be easily dropped, lost or placed on the incorrect fingers. These methods also reinforce the unfavorable habit of looking at the keyboard while typing.

Several more technologically advanced methods have been proposed to promote better typing skills In one method, the typist wears a finger detector which, when pressed on a keyboard key, sends a signal to the PC main body which can determine if an improper key was selected. The computer then relates this error by generating a sound. Another device uses magnets attached to the student's finger tips which are then magnetically drawn to electrically charged corresponding keyboard keys. A drawback to both of these systems is that the expense of purchasing the needed technology would place them out of reach of most families and school systems.

In yet another method the tactile sensation of the home row keys is increased by either placing caps with raised edges over these keys or by replacing the standard keys with others with raised edges. While this method does help the typist find the home row keys without looking at the keyboard, it does not help the typist's fingers to easily find and learn the remaining keys.

Another type of device is a keyboard with keys that are all completely blank, thus decreasing dependency on visual key feedback. While this does help prevent the learner from looking at the keys, it does nothing to assist with proper placement of the fingers.

These solutions do not address the needs of those who have difficulty with finger coordination. Nor are they designed to prevent errors caused by incorrect finger placement. This is a key problem in teaching touch-typing, because once errors are made, it is easy for those errors to become learned and the mistake perpetuated.

Thus, there is a need for an inexpensive device and methodology to teach touch-typing skills to children younger than the 3rd grade who have not yet developed refined fine motor skills, to those with learning disabilities, and to those who have not achieved success using the standard method of instruction. There is a need to have a systematic, multi-sensory structured approach to teaching keyboarding that by design reduces the chances of errors thereby reinforcing psychomotor learning. In addition, there is a need for a methodology that actively engages the child in the learning process.

### SUMMARY

This invention provides an instructional model employing a keyless-keyboard with insertable keys and an optional accompanying instructional computer program. The keys are only inserted into the keyboard as the individual letters are taught, thus making it easier to learn by feel and eliminating errors. Using this approach, students would begin on a keyboard that is void of any keys. They would then begin learning the keys by inserting either the home row keys (A S D F J K L;) or the pointer finger keys (F and J). By only having a limited number of keys inserted into the keyboard, the user's hands can instantly find the home row keys (or the pointer finger keys) without error or the need to look down at the letters; there is no place else for the fingers to go as the rest of the keyboard remains keyless. Once the students have mastered the initial keys, new ones are systematically inserted into the keyboard as directed by the accompanying computer program. This process continues until all the keys have been learned and all of the keys have been inserted. The student has actively built up the keyboard as he/she has learned to type.

This invention overcomes the disadvantages of the prior art by providing an inexpensive method to teach touch typing that increases tactile and kinesthetic feedback thereby reducing errors and promoting a faster and more efficient method of learning touch-typing. This method provides a multi-sensory systematic form of instruction as is recommended for the education of young children and individuals with learning issues. Additionally, this method is interactive since the learner constructs the keyboard (through the addition of the keys) as he/she is learning to type. By participating in the construction of the keyboard, the student is able to measure his/her own gains and experience the positive reinforcement of their success.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

The invention description below refers to the accompanying drawings, of which:

FIG. 1 is a front view of the keyboard of the present invention prior to insertion of the letter, number, and function keys.

FIG. 2 is a front view of the keyboard of the present invention showing the home keys (A S D F J K L;) inserted.

FIG. 3 is a front view of the keyboard of the present invention showing the function keys inserted along with additional letters.

FIG. 4 is a front view an alternative embodiment of the keyboard of the present invention in which the keys to be taught are housed in a recessed area.

### DETAILED DESCRIPTION

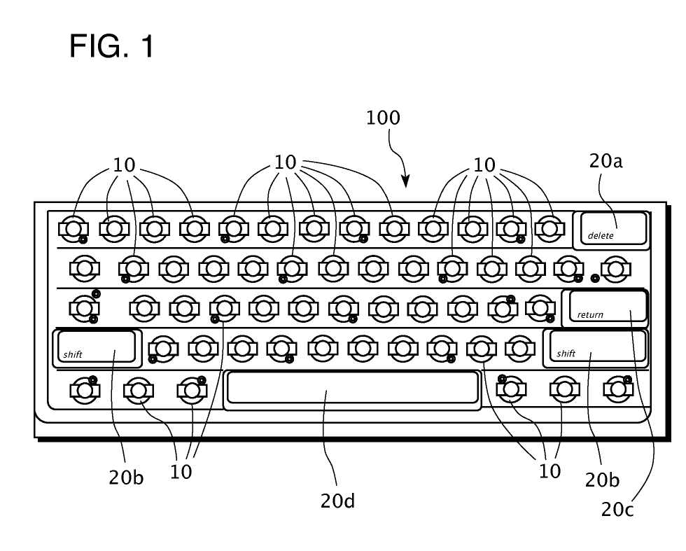

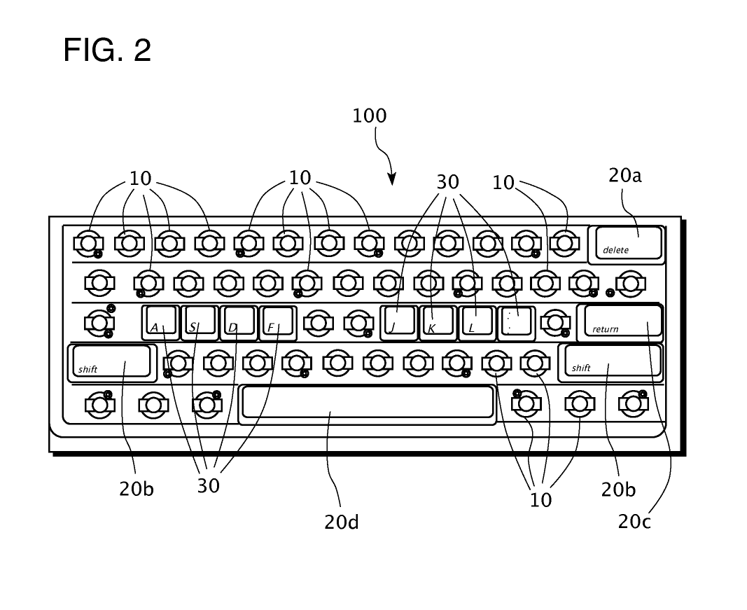

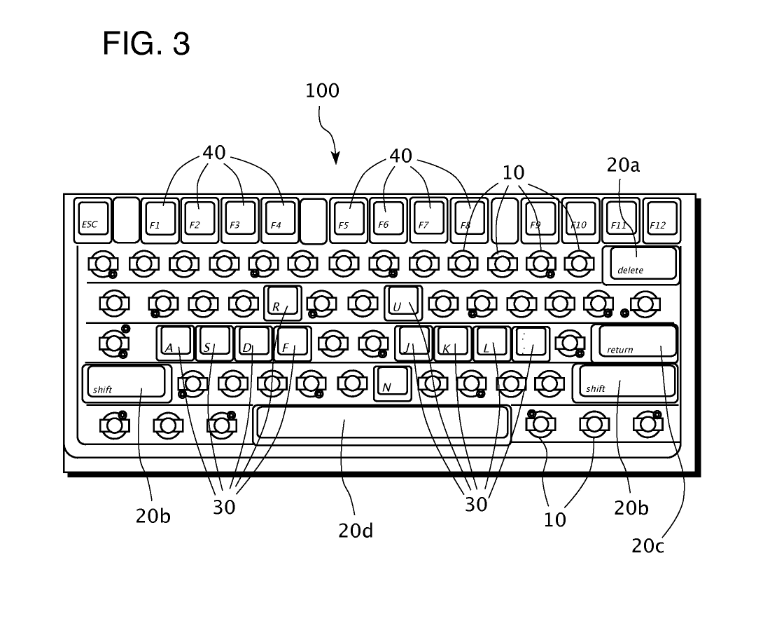

As seen in FIGS. 1-4, the invention consists of a computer keyboard 100 and a typing program designed to facilitate the learning of touch-typing. FIG. 1 illustrates a keyboard with all of the alphanumeric and function keys removed from their retaining clips 10, except the “Delete” key 20a, “Shift” key 20b, “Return” keys 20c and the space bar 20d. As shown in FIG. 2, rather than starting with an intact keyboard with all of the alphanumeric keys 30 and function keys 40 in place, instruction begins with keyboard 100 devoid of any keys 30, 40 other than the entire set of home keys (A S D F J K L ;). In another embodiment (not shown), the start keys may be the letters “F” and “J” which are the pointer finger keys of the home row (A S D F J K L ;). In this way, students are able to easily master key placement without looking at the keys because they are the only keys on the keyboard and there is no other place for the user to place their fingers. A computer program is used to show the students which keys to insert e.g.: the home row keys “ASDFJKL;” or the pointer finger keys “F” and “J” as well as proper finger placement on said keys. The program will present an instructional sequence where student learn individual letters. Following mastery of the initial keys, new ones are inserted into the keyboard individually, as shown in FIG. 3. In another embodiment, new keys are added in groups of two. At all times, the spaces for the remainder of the keys are empty. This positive and negative space allows the student to find the keys effortlessly as there are no other keys for which the user to place their fingers. As instruction proceeds, each newly taught key is added to the keyboard until it is completely filled. This approach reinforces correct finger placement by providing tactile clues, which aids in kinesthetic memory.

In one embodiment of the invention (not shown), the placement of keys into the keyboard is specified by a light or other signal on the keyboard at the point where the key is to be inserted. The computer program provides the student with immediate feedback since it will signal when the correct key is typed and/or an error is made. Additionally, the computer program presents lessons, mastery tests, feedback on errors, statistics on errors, and games to aid in the learning process.

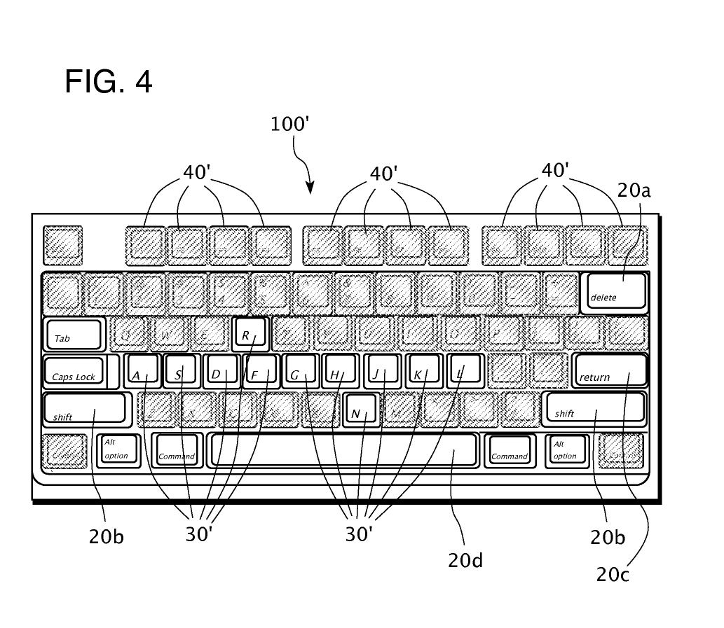

In an alternative embodiment, shown in FIG. 4, the keyboard 100′ is designed such that the keys may be raised or lowered via a retraction mechanism. As keys are taught, the keyboardist raises the keys to the higher plane by depressing the keys and releasing the retraction mechanism, so the key is available for typing. The other plane, which is recessed into the keyboard, contains keys that are yet to be taught. This recessed plane is shown by the shaded keys 30′ in FIG. 4. Rather than inserting keys as the letters are being learned, the keyboardist raises the keys onto a higher plane, e.g.: the surface level, on the keyboard to access them.

In one embodiment (not shown), the keys are blank with no letters printed on them. Because there are no letters printed on the keys, the student's desire to look down at the keyboard is eliminated. Alternatively, the blank keys may be sold separately, such that they may be substituted into an existing keyboard. In another embodiment, the keys are printed with letters on them. Alternatively, the keys may use other characters for other types of languages, e.g.: Chinese, Arabic, European or any other language.

The keyboard may include all other keys normally found on a keyboard, in which these other keys are provided with their markings indicating what the keys do. Thus, for example, the other keys may be keys giving numbers, punctuation marks, shift, tab, enter, escape, function and arrow. Alternatively, these keys may be removed as well.

These embodiments reduce the need to have two separate keyboards, one for learning and one for general use.

The keyboard may also have a storage drawer incorporated into it for storage of the keys when not in use.

The keyboard may be a split keyboard or a small keyboard.

The keyboard may include a CD ROM storage slot for receiving a CD ROM giving instruction on touch-typing. Alternatively, the computer program may installed onto the hard drive of the computer.

The keyboard may be of various differing known designs. Thus, for example, the keyboard may be a typing keyboard as found on a typewriter, e.g. QWERTY style layout. Alternatively, the keyboard may be one which contains a separate numeric keypad and a cursor keypad. In a separate embodiment, the keyboard may also be a musical keyboard wherein the keys represent musical notes.

The keyboard may be such that it is able to be connected to a computer, e.g: a personal computer, an Apple Mac, or a laptop computer. The keyboard may also be able to connect to any other electronic device that requires the use of a keyboard. The keyboard may be connected to the computer or other device by a cable or by a wireless connection such for example as infrared, Bluetooth or any other wireless protocol.

Where the keyboard requires power, this may be provided by either batteries stored in the keyboard or by a connection, e.g.: USB port, to the computer or peripheral to which the keyboard may be attached.

The foregoing has been a detailed description of illustrative embodiments of the invention. Various modifications and additions can be made without departing from the spirit and scope if this invention. Each of the various embodiments described above may be combined with other described embodiments in order to provide multiple features. Furthermore, while the foregoing describes a number of separate embodiments of the apparatus and method of the present invention, what has been described herein is merely illustrative of the application of the principles of the present invention. Accordingly, this description is meant to be taken only by way of example, and not to otherwise limit the scope of this invention.

What is claimed is:

1. A keyboard for use in teaching touch-typing comprising:
a keyboard body; and
a plurality of keys, the plurality of keys being insertable into the keyboard body, wherein an individual key is inserted onto the keyboard body so that a user learns a position of the individual key on the keyboard body without having to look at the individual key.

2. The keyboard for use in teaching touch-typing of claim 1 wherein once the position of the individual key is learned, another one of the plurality of keys is inserted onto the keyboard body.

3. The keyboard for use in teaching touch-typing of claim 1 wherein the plurality of keys are blank with no letters printed on the keys.

4. The keyboard for use in teaching touch-typing of claim 1 wherein the keyboard body further comprises a drawer for storage of the plurality of keys.

5. The keyboard for use in teaching touch-typing of claim 1 wherein the keyboard body further comprises a CD ROM storage slot for receiving a CD ROM giving instruction on touch-typing.

6. The keyboard for use in teaching touch-typing of claim 1 wherein the plurality of keys are inserted in a QWERTY design layout.

7. The keyboard for use in teaching touch-typing of claim 1 wherein the plurality of keys are inserted in a non-QWERTY design layout.

8. The keyboard for use in teaching touch-typing of claim 1 wherein the placement of the plurality of keys into the keyboard is specified by a light signal on the keyboard at the point where the key is to be inserted.

9. A method of teaching touch-typing comprising:
providing a keyboard body having a plurality of keys;
removing all of the plurality of keys from the keyboard body;
selecting one of the plurality of keys and inserting the selected key onto the keyboard body;
instructing the user to perform a series of exercises such that the user learns the position of the selected key on the keyboard body by tactile learning without having to look at the selected key;
repeating the selection and insertion of the plurality of keys onto the keyboard body until the user learns the position of all of the plurality of keys.

10. The method of teaching touch-typing of claim 9 wherein the series of exercises is contained on a CD-ROM.

11. The method of teaching touch-typing of claim 9 wherein the series of exercises is contained in printed instructions.

12. The method of teaching touch-typing of claim 9 further comprising specifying a location on the keyboard where each of the plurality of keys is to be inserted via a light signal.

13. A keyboard for use in teaching touch-typing comprising:
a keyboard body, wherein the keyboard body further comprises a recessed area, wherein the recessed area houses a plurality of keys to be taught, wherein the keys selected from the group consisting of alphanumeric keys, function keys and a combination thereof, wherein the keys are positioned in the recessed area such that the keys to be taught are on a lower plane and a remainder of keys are positioned on an upper plane.

14. The keyboard for use in teaching touch-typing of claim 13 wherein the keys to be taught are raised approximately ¼ inch in order to reach the upper plane of the keyboard as needed for typing.

15. The keyboard for use in teaching touch-typing of claim 13 wherein the keys to be taught are attached to the recessed area by a retraction mechanism.

16. The keyboard for use in teaching touch-typing of claim 13 wherein depression of one of the keys to be taught releases the retraction mechanism and the key to be taught is positioned on the upper plane with the remainder of keys on the keyboard body.

17. The keyboard for use in teaching touch-typing of claim 13 wherein the key to be taught is lowered from the upper plane of the keyboard body to the recessed area prior to instruction.

18. The keyboard for use in teaching touch-typing of claim 13 wherein the key to be taught is raised to the upper plane of the keyboard body for typing instruction.

19. The keyboard for use in teaching touch-typing of claim 13 wherein positioning of the key to be taught on the upper plane allows a user to learn a position of the key to be taught on the key- board body without having to look at the key to be taught.

20. A method of teaching touch-typing comprising:
providing a keyboard body, wherein a plurality of keys to be taught are positioned in a recessed area of the keyboard body such that the to be taught keys are on a lower plane and a remainder of keys are positioned on an upper plane;
selecting and depressing one of the keys to be taught to release a retraction mechanism to position the key to be taught on the upper plane with the remainder of keys on the keyboard body;
instructing the user to perform a series of exercises such that the user learns the position of the selected key to be taught on the keyboard body by tactile learning without having to look at the selected key to be taught;
repeating the selection and depression of the plurality of keys to be taught on the keyboard body until the user learns the position of all of the keys to be taught.
